(19) United States
(12) Patent Application Publication
(10) Pub. No.: US 2008/0102829 A1
(43) Pub. Date: May 1, 2008

(54) Method and system for providing prepaid roaming support at a visited network that otherwise does not provide it

(75) Inventor: John Yue Jun Jiang, Danville, CA (US)

Correspondence Address: ARENT FOX LLP, 1050 CONNECTICUT AVENUE, N.W., SUITE 400, WASHINGTON, DC, 20036, US

(73) Assignee: ROAMWARE, INC.

(21) Appl. No.: 11/882,087

(22) Filed: Jul. 30, 2007

Related U.S. Application Data
(60) Provisional application No. 60/833,779, filed on Jul. 28, 2006.

(51) Int. Cl. H04Q 7/20

(52) U.S. Cl. 455/433

(57) ABSTRACT

The present invention provides a method for providing wireless services to a prepaid subscriber of an HPMN in a VPMN when the prepaid subscriber attempts to register at the VPMN having a non-WIN phase 2 support. The method includes detecting at a Signal Gateway (SG) coupled to the VPMN, a registration attempt by the prepaid subscriber at the VPMN. The method further includes causing by the SG, an HLR associated with the HPMN to send a trigger profile information in a registration acknowledgement message to the SG in response to a modified registration message, sent by the SG, so as to imitate the VPMN's roaming support for WIN phase 2 at the HLR having a WIN phase 2 support. Finally, the method includes sending a modified registration acknowledgement message by the SG, to a VMSC/VLR associated with the VPMN to facilitate the prepaid subscriber's mobile communication in the VPMN.

### RELATED APPLICATIONS

This application claims priority from U.S. Provisional Patent Application Ser. No. 60/833,779 entitled “A prepaid CDMA roaming solution between an operator of WIN Phase 2 and an operator of WIN phase 1 or non-WIN support” filed on Jul. 28, 2006. The aforementioned provisional patent application is incorporated herein by this reference in its entirety.

### FIELD OF THE INVENTION

The present invention generally relates to mobile communication of roamers. More specifically, the invention relates to facilitating mobile communication for prepaid roamers of a home network while they are roaming in a visited network that does not provide prepaid roaming services similar to the service offerings in their home network.

### BACKGROUND OF THE INVENTION

Mobile communication services to roaming subscribers are becoming increasingly popular with increasing number of roamers. Network operators across the world tend to earn maximum revenues from these roamers. Roaming subscribers who visit different countries or states add to the majority of this roaming revenue. Hence, many of these network operators offer international or national roaming to inbound roamers visiting their coverage area. Additionally, these network operators tend to offer the latest technologies and Value Added Services (VAS), such as General Packet Radio System (GPRS), etc to national or international roamers enticing them to remain connected to their network, thereby increasing the operators' overall revenue.

Usually, the network operators have preferred bilateral roaming agreements (“partnerships”) with each other that include more favorable roaming charges than that of non-partnership operators. Therefore, “preferred” visited networks are those that the home network prefers its outbound roamers (or subscribers) to register with, when traveling outside their home coverage area. Non-partner networks are “non-preferred” networks. Hence, the network operators can maximize their margins and even the roamers can get more attractive roaming rates and better services if the outbound roamers roam on their home operator's preferred (or partner) networks. However, these outbound roamers may manually select any of the network operators available in their roaming territory based on maximum benefits like latest technology offerings and favorable roaming charges. For example, if the outbound roamer's home network offers them prepaid services like VAS based on Wireless Intelligent Network (WIN) phase 2 then ideally these outbound roamers would like to continue using similar WIN phase 2 services while roaming in coverage of a visited network operator. Even the home network operator may like their outbound roaming subscribers to roam in a ‘preferred’ visited network that supports such services similar to the offerings of the home network operator. Similarly, even a Mobile Virtual Network Operator (MVNO) of the home network operator that is offering wireless services to the subscribers of home network operator would prefer its subscribers to register at the preferred visited network that supports WIN phase 2 roaming services.

In Global System for Mobile communications (GSM), the partner visited network operator may provide prepaid roaming to outbound roamers of the home network that has a Customized Application for Mobile Enhanced Logic (CAMEL) support via an Unstructured Supplementary Service Data (USSD) call back service, in case the partner visited network operator does not possess roaming support for CAMEL. However, in case the partner visited network operator supports CAMEL roaming with the home network operator, then the prepaid roaming is facilitated via CAMEL protocol without the need of USSD call back service.

Likewise, in Code Division Multiple Access (CDMA), despite the equivalent of USSD being a feature code trigger, rarely does any of the CDMA network operators implement prepaid roaming via this feature code trigger generated call back. Instead, they use CDMA WIN phase 2 protocol (an equivalent of GSM CAMEL protocol) to implement CDMA prepaid roaming for their outbound roamers. Some operators such as Verizon and China Unicom have implemented WIN phase 2 protocol that support their prepaid subscribers' roaming between these two networks. Postpaid subscribers of Verizon may roam in CDMA networks in different countries or regions, such as, but not limited to, Dominican Republic, Israel, Mexico, Puerto Rico, South Korea, and Venezuela. However, many of the network operators in these countries or regions do not support WIN phase 2 protocol with the home network operator. Hence, this poses a problem for prepaid subscribers of the home network operator, as these subscribers are unable to avail WIN phase 2 services while roaming in the partner visited network. Even some MVNO operators of Verizon such as Digicel USA may also like its prepaid subscribers to outbound roam in Latin American countries like Mexico.

However, one or more of existing solutions did not consider the scenario where a partner visited network operator having a non-WIN phase 2 support (or a non-CAMEL support) could offer WIN phase 2 roaming services (or CAMEL services) to the prepaid subscribers of the home network that supports WIN phase 2 (or CAMEL). Moreover, in order to provide such WIN phase 2 (or CAMEL) services, these network operators need to upgrade various network elements like Home Location Register (HLR) and Mobile Switching Center (MSC) in their network infrastructure, which increases the overall cost.

In accordance with the foregoing, there is a need in the art of a system, a method, and a computer product, which allows prepaid subscribers of a home network with WIN phase 2 (or CAMEL) capabilities to outbound roam with similar WIN phase 2 (or CAMEL) support in a non-WIN phase 2 (or non-CAMEL) partner visited network. This enables these prepaid subscribers to avail services specific to WIN phase 2 (or CAMEL) protocol, in addition to standard call and non-call related services, while roaming in the partner visited network.

### SUMMARY

The present invention is directed towards a system for providing wireless services to a prepaid subscriber, associated with an HPMN, in a VPMN when the prepaid subscriber attempts to register at the VPMN that has a non-WIN phase 2 support. The system includes a Signal Gateway (SG) for detecting a registration attempt by the prepaid subscriber at the VPMN. The SG is coupled to the VPMN and causes an HLR associated with the HPMN to send a trigger profile information in a registration acknowledgement message to the SG in response to a modified registration message that is sent by the SG, so as to imitate the VPMN's roaming support for WIN phase 2 at the HLR having a WIN phase 2 support. Finally, the SG sends a modified registration acknowledgement message to a VMSC/VLR associated with the VPMN to facilitate the prepaid subscriber's mobile communication in the VPMN.

Another aspect of the invention presents a method for providing wireless services to a prepaid subscriber, associated with an HPMN, in a VPMN when the prepaid subscriber attempts to register at the VPMN having a non-WIN phase 2 support. The method includes detecting at an SG, a registration attempt by the prepaid subscriber at the VPMN. The SG is coupled to the VPMN. The SG further causes an HLR associated with the HPMN to send a trigger profile information in a registration acknowledgement message to the SG, in response to a modified registration message being sent by the SG, so as to imitate the VPMN's roaming support for WIN phase 2 at the HLR. The HPMN HLR having a WIN phase 2 support. Finally, the method includes sending a modified registration acknowledgement message by the SG, to a VMSC/VLR associated with the VPMN to facilitate the prepaid subscriber's mobile communication in the VPMN.

Yet another aspect of the present invention provides a computer program product including a computer usable program code for providing wireless services to a prepaid subscriber of an HPMN in a VPMN by detecting at an SG coupled to the VPMN, a registration attempt by the prepaid subscriber at the VPMN having a non-WIN phase 2 support. Thereafter, causing by the SG, an HLR associated with the HPMN to send a trigger profile information in a registration acknowledgement message to the SG in response to a modified registration message being sent by the SG, so as to imitate the VPMN's roaming support for WIN phase 2 at the HLR having a WIN phase 2 support. Finally, sending a modified registration acknowledgement message by the SG, to a VMSC/VLR associated with the VPMN to facilitate the prepaid subscriber's mobile communication in the VPMN.

### BRIEF DESCRIPTION OF DRAWINGS

In the drawings, the same or similar reference numbers identify similar elements or acts.

FIG. 1 represents a system for providing a CDMA roaming solution to prepaid subscribers of a WIN phase 2 capable HPMN in a non-WIN phase 2 partner VPMN, in accordance with an embodiment of the present invention;

FIG. 2 is a flowchart for implementing the CDMA roaming solution in the partner VPMN, in accordance with an embodiment of the present invention;

FIG. 3 represents a flow diagram of a registration process of the prepaid subscriber in the partner VPMN, in accordance with an embodiment of the present invention;

FIGS. 4A, 4B, and 4C represent a flow diagram of Mobile Originated (MO) call from the prepaid subscriber's handset while roaming in the partner VPMN, in accordance with an embodiment of the present invention; and

FIGS. 5A, 5B, and 5C represent a flow diagram of Mobile Terminated (MT) call received on the prepaid subscriber's handset while roaming in the partner VPMN, in accordance with an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the invention. The appearance of the phrase “in an embodiment”, in various places in the specification, does not necessarily refer to the same embodiment.

The present invention provides a system, a method, and a computer program product that allows prepaid subscribers of a Wireless Intelligent Network (WIN) phase 2 capable home network to access various WIN phase 2 prepaid services in a partner visited network that does not have WIN phase 2 support. The partner visited network either may have WIN phase 1 support or may even have no WIN support, both of which are hereinafter interchangeably referred to as non-WIN phase 2 support. It will be apparent to a person skilled in the art that the wireless services include standard call and non-call related activities, such as, but not limited to, MO call, MT call, Short Message Service (SMS), Packet Data Network (PDN), and other Value Added Services (VAS) such as SMS forwarding and SMS filtering. Furthermore, WIN protocol allows network operators to add various capabilities to their existing network infrastructure. However, this requires these network operators to perform some software upgrades in their respective network components, or install additional network components such as, but not limited to, Service Control Points (SCPs), Service Nodes (SNs), or Intelligent Peripherals (IPs) to their existing network infrastructure. For example, an operator ‘X’ having WIN phase 1 capabilities may like to upgrade to WIN phase 2, for which it needs to upgrade or install some or all of the above mentioned components. Upgrading to WIN phase 2 allows the operator ‘X’ to add triggers and other capabilities to its network that supports various charging services such as Prepaid, Freephone, Premium Rate, and Advice of Charging (AoC). The system in accordance with various embodiments of the present invention, allows the non-WIN phase 2 network operators to provide WIN phase 2 prepaid services to the WIN phase 2 prepaid subscribers without performing any software upgrades and installing the above mentioned components to their existing infrastructure. The present system also ensures that the home network operator does not need to modify any roaming profile information, associated with its prepaid subscribers, in its Home Location Register (HLR).

Similarly, in case of Global System for Mobile communication (GSM), the present system allow prepaid subscribers of a Customized Applications for Mobile network Enhanced Logic (CAMEL) phase 3 capable home network roaming in a non-CAMEL partner visited network to use various CAMEL capable prepaid services. The partner visited network either may have CAMEL phase 2 (or phase 1) support or may not even have CAMEL support, all three of which are hereinafter interchangeably referred to as non-CAMEL support. A mapping table between GSM and CDMA standards correlating various MAP messages used in case of CAMEL/Intelligent Network (IN) and American National Standards Institute #41 (ANSI-41) based networks are described later in context of the present invention.

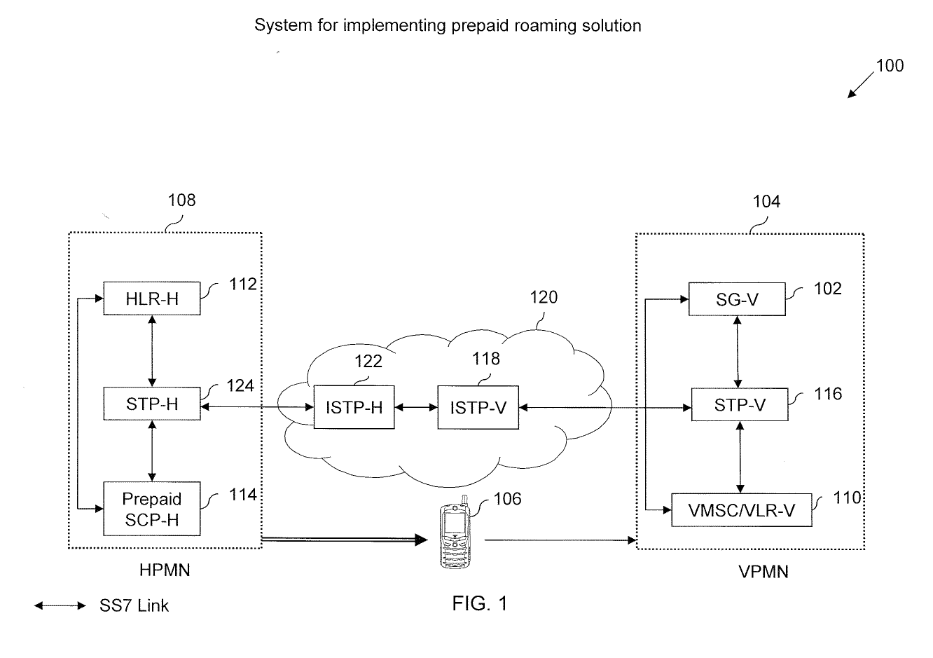

In order to provide WIN phase 2 prepaid services to these prepaid subscribers, the partner visited network operator needs to emulate/fake their support for WIN phase 2 support, while these prepaid subscribers are roaming in the partner visited network. This creates a false impression on the home network operator, thereby allowing the prepaid subscribers to register and avail WIN phase 2 prepaid services in the partner visited network. FIG. 1 represents a system 100 for providing a CDMA roaming solution to the prepaid subscribers, in accordance with an embodiment of the present invention. System 100 includes a Signal Gateway (SG) 102 coupled to a partner Visited Public Mobile Network (VPMN) 104 (i.e. the partner visited network) to allow a prepaid subscriber 106 of a Home Public Mobile Network (HPMN) 108 (i.e. the home network) to register at partner VPMN 104. Hence, despite of not having WIN phase 2 support an operator in partner VPMN 104 is able to provide the WIN phase 2 services to prepaid subscriber 106 using SG 102. Hereinafter, for sake of convenient reference, prepaid subscriber 106 is interchangeably referred to as subscriber 106. Since the WIN phase 2 prepaid services are applicable only for partner VPMN 104, it is hereinafter interchangeably referred to as VPMN 104, in accordance with various embodiments of the present invention. Furthermore, as SG 102 resides in VPMN 104, it is hereinafter interchangeably referred to as SG-V 102. In an alternate embodiment of the present invention, a Mobile Virtual Network Operator (MVNO) of HPMN 108 enables these services by deploying SG 102 in its network. It will be apparent to a person skilled in the art that the functionalities of SG 102 remain unchanged irrespective of its location.

System 100 further includes in VPMN 104, a Visitor Location Register (VLR) 110 that is integrated with a Visited Mobile Switching Center (VMSC) in VPMN 104. As VLR 110 and its integrated VMSC reside in VPMN 104, collectively they are interchangeably referred to as VMSC/VLR-V 110. However, both the VLR and the VMSC may have different logical addresses. Additionally, HPMN 108 includes a HLR 112 and a prepaid SCP 114. As HLR 112 and prepaid SCP 114 reside in HPMN 108, they are hereinafter referred to as HLR-H 112 and prepaid SCP-H 114, respectively. It will be apparent to a person skilled in the art that HLR-H 112 stores profile data corresponding to all subscribers of HPMN 108. Prepaid SCP-H 114 is used to control and perform various subscriber (or application specific service) logic in response to a query from a Service Switching Point (SSP), which is VMSC/VLR-V 110 (and SG-V 102 in some cases).

Subscriber 106's signaling in VPMN 104 is routed via a roaming Signaling Transfer Point (STP) 116 and an International STP (ISTP) 118 to HPMN 108. Since STP 116 and ISTP 118 reside in VPMN 104, they are hereinafter referred to as STP-V 116 and ISTP-V 118, respectively. Similarly, subscriber 106's signaling in HPMN 108 is routed to VPMN 104 using Signaling System #7 (SS7) signaling architecture 120 that involves an International STP-H 122 connected to a roaming STP-H 124 in HPMN 108. The signals exchanged between different networks are Transaction Capabilities Application Part (TCAP) including Mobile Application Part (MAP), Camel Application Part (CAP) and the like based signals. In another embodiment of the present invention, the signals exchanged are Signaling Connection Control Part (SCCP) based routing signals. It would be apparent to a person skilled in the art that any network element in HPMN 108 and VPMN 104 may communicate with each other via SS7 signaling architecture 120. It would also be apparent to a person skilled in the art that VPMN 104 and HPMN 108 may also include various other network components (not shown in FIG. 1), depending on the architecture under consideration.

SG-V 102 interacts with various components in HPMN 108 via a WIN phase 2 protocol, as HPMN 108 supports WIN phase 2. However, while interacting with various components in VPMN 104, SG-V 102 uses an ISDN User Part (ISUP) protocol, as VPMN 104 does not support WIN phase 2. Since SG-V 102 communicates with HPMN 108 via WIN phase 2 protocol and with VPMN 104 via ISUP protocol, it can use TCAP transaction identifiers to correlate ANSI-41 (or IS-41) and GSM MAP/CAP operations. Furthermore, SG-V 102 either can use a Global Title (GT) and a Signal Point Code (SPC) of VPMN 104, or may select a GT and a SPC from a pool of GTs and SPCs that are allocated by the operator in VPMN 104 to communicate with various components in VPMN 104 and HPMN 108. In case, when SG-V 102 uses the GT and the SPC of VPMN 104, SG-V 102 needs to maintain subscriber 106's location information, such as HLR-H 112 and VMSC/VLR-V 110, in addition to roaming profile information (i.e. WIN phase 2 profile) corresponding to subscriber 106. However, in case of pool of GTs and SPCs, SG-V 102 only needs to maintain roaming profile information corresponding to subscriber 106.

Since the operator in VPMN 104 installs SG-V 102 in its network, the operator in HPMN 108 does not require modifying its HLR (i.e. HLR-H 112) for subscriber 106. Furthermore, SG-V 102 applies various application logics when interacting with HPMN 108 and VPMN 104 to facilitate subscriber 106's mobile communication in VPMN 104. In an embodiment of the present invention, SG-V 102 adds a configurable prefix to a Mobile Directory Number (MDN) of subscriber 106 during an ongoing registration process of subscriber 106 in VPMN 104. This ensures that when a call on the prefixed MDN of subscriber 106 is received at VMSC/VLR-V 110, VMSC/VLR-V 110 based on the prefix determines that the call needs to be routed to SG-V 102. In an embodiment of the present invention, all calls initiated by the prepaid subscribers of HPMN 108, who have subscribed to the CDMA roaming solution will be redirected to SG-V 102 based on the prefix to their MDNs. Therefore, when SG-V 102 receives a call request on the prefixed MDN from VMSC/VLR-V 110, SG-V 102 removes the prefix and performs other necessary functions (e.g. assists VMSC/VLR-V 110 in establishing call setup with called party GMSC) to facilitate subscriber 106's mobile communication in VPMN 104.

In order to allow subscriber 106 to initiate calls in VPMN 104, the operator in VPMN 104 configures its switch (i.e. VMSC/VLR-V 110) based on prefixes of calling number. In an embodiment of the present invention, VMSC/VLR-V 110 routes an ISUP call to SG-V 102 when prefix of a calling number is known to be configured by the operator in VPMN 104. Logistically, VMSC/VLR-V 110 creates either an ISUP voice trunk loopback or an ISUP signaling to SG-V 102 in order to route all signaling messages corresponding to subscriber 106. In case of ISUP voice trunk loopback interface to SG-V 102, loopback circuits in VMSC/VLR-V 110 are configured for the prefixes of calling numbers. These calling number prefixes are configurable by VPMN 104 operator. In this case, only an ISUP signaling is redirected via SG-V 102, whereas the voice trunks are created within VMSC/VLR-V 110 using loopback circuits. In an alternate case involving ISUP signaling interface to SG-V 102, VMSC/VLR-V 110 is configured for prefixes of calling numbers to redirect both the ISUP signaling and voice trunking via SG-V 102, and hence no loopback circuits are created in this case.

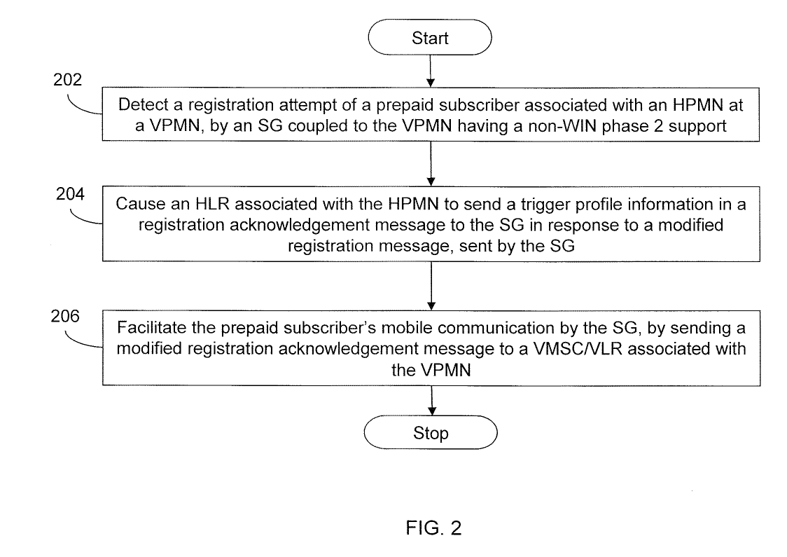

Interfacing VMSC/VLR-V 110 with SG-V 102 allows the operator in VPMN 104 to handle calls associated with subscriber 106 (i.e. based on prefix of the calling number, in case of MO calls), while subscriber 106 is roaming in VPMN 104. Moreover, the mobile activities performed by subscriber 106 in VPMN 104 are based on WIN phase 2, even when VPMN 104 does not support WIN phase 2 capabilities. FIG. 2 is a flowchart for implementing the CDMA roaming solution in the partner VPMN, in accordance with an embodiment of the present invention. At step 202, an SG coupled to a VPMN detects a registration attempt of a prepaid subscriber associated with an HPMN at the VPMN. Although the prepaid subscriber comes from the HPMN that has WIN phase 2 support, the VPMN does not have such support. In an embodiment of the present invention, SG-V 102 detects a registration attempt of subscriber 106 at VPMN 104, upon receiving a registration message such as MAP Registration Notification (REGNOT) from VMSC/VLR-V 110. REGNOT message is used to provide the location of subscriber's handset and optionally, to validate the subscriber's handset and obtain its profile information. In other words, REGNOT message provides the current location of subscriber at HLR-H 112, and is similar to a combination of MAP Location Update (LUP) and MAP Insert Subscriber Data (ISD) messages in GSM standard. SG-V 102 may then apply various application logics to emulate VPMN 104's WIN phase 2 support at HLR-H 112, in order to facilitate the registration process.

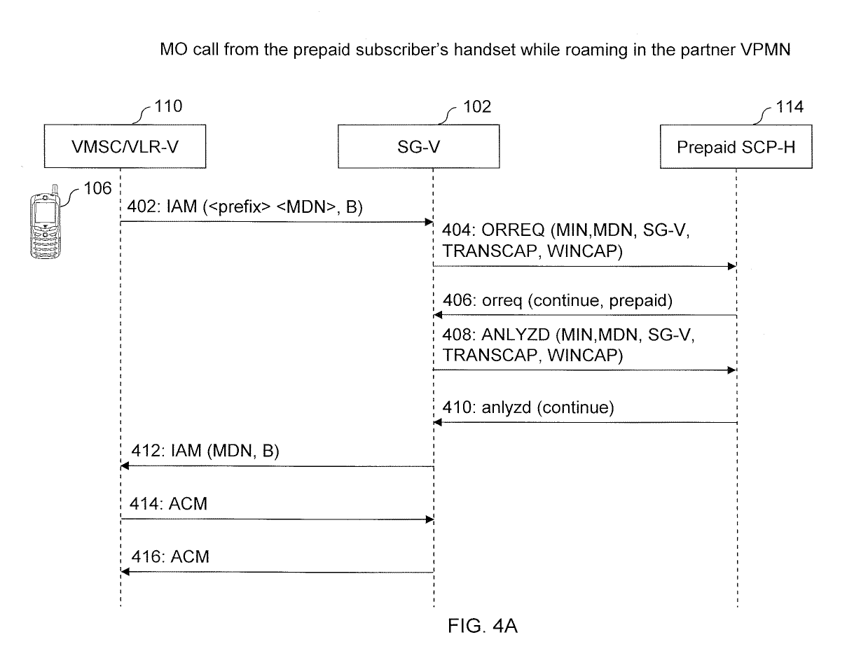

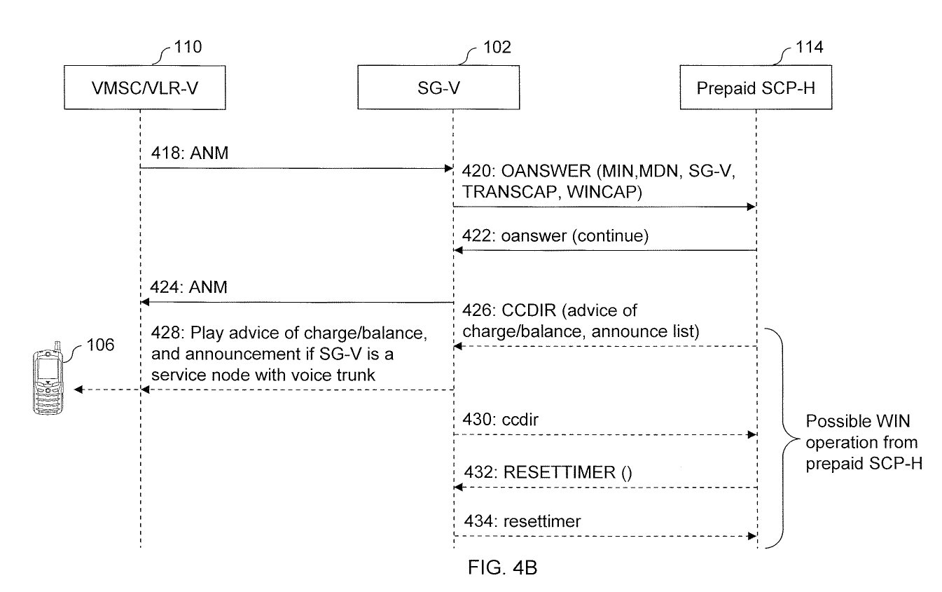

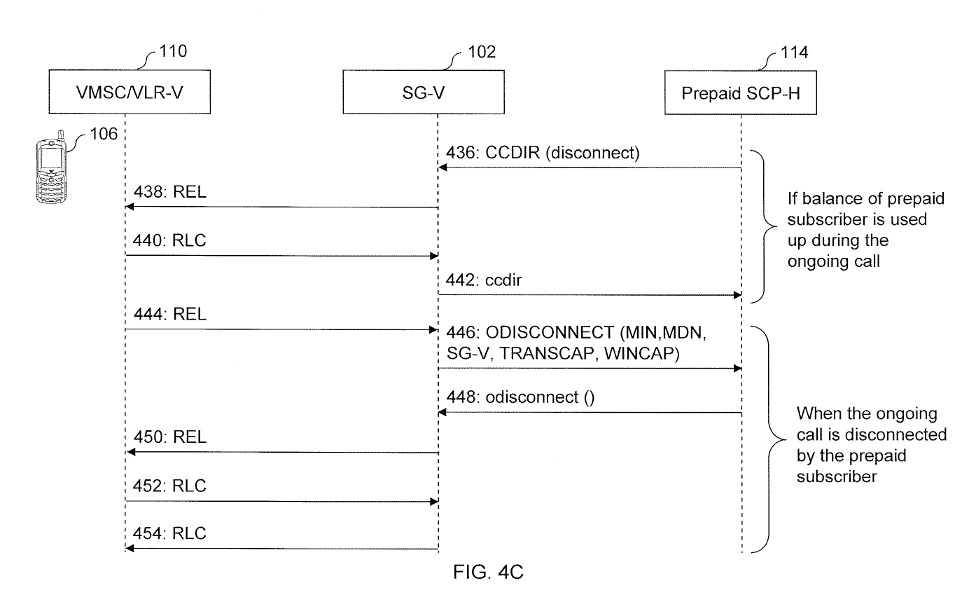

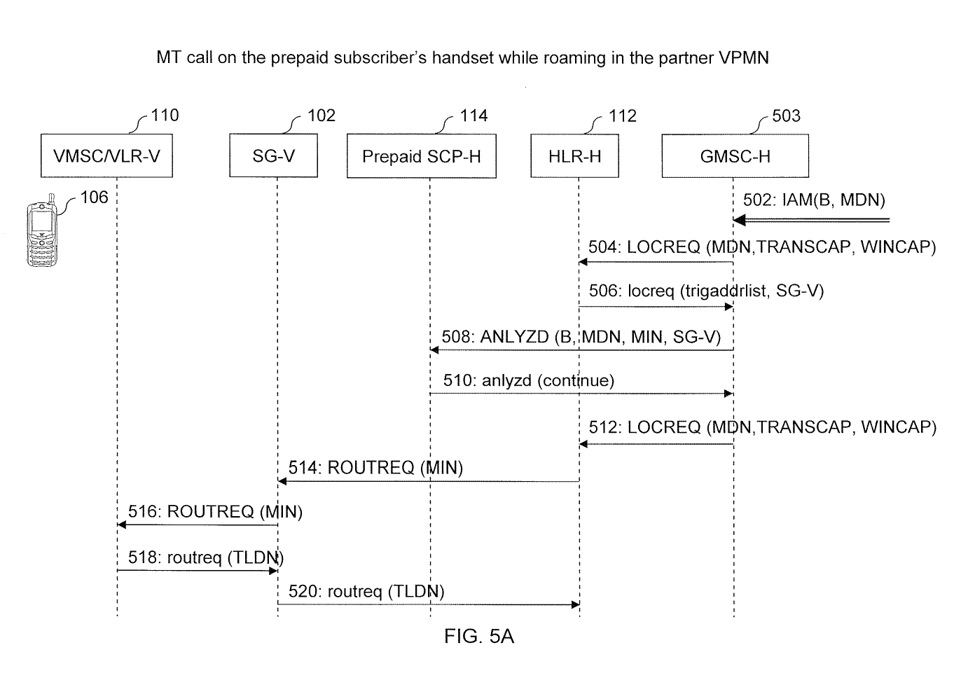

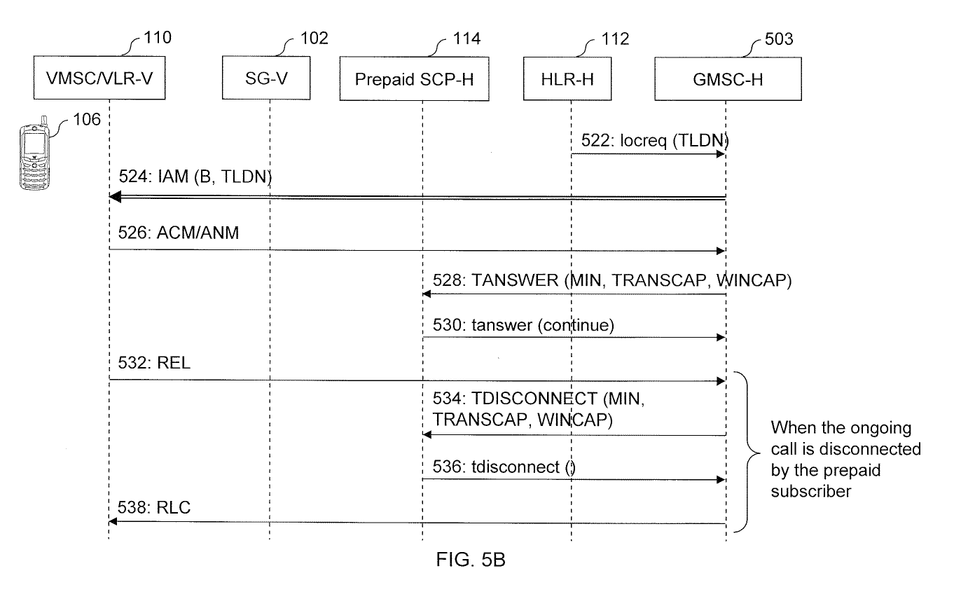

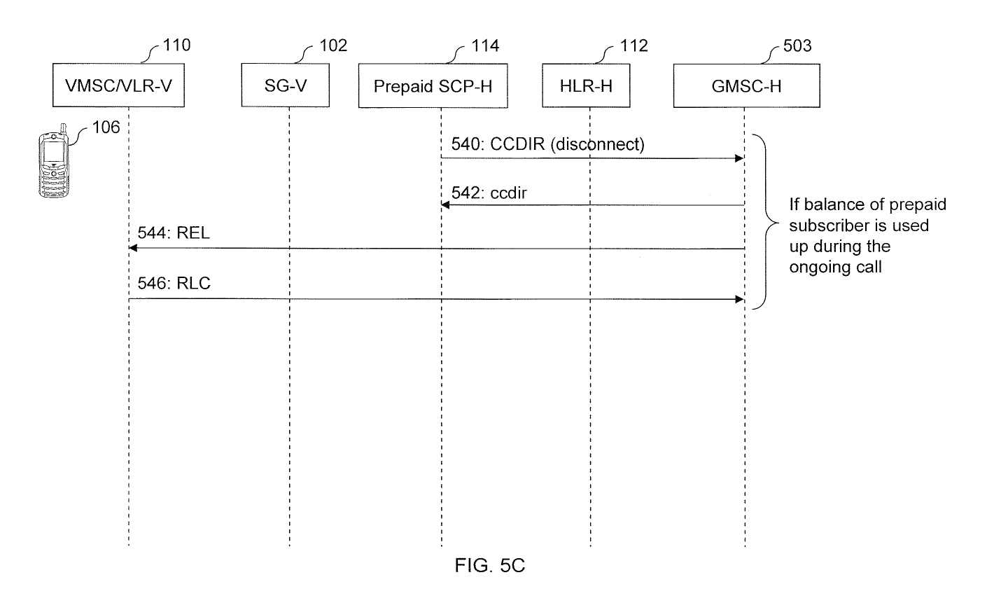

At step 204, the SG modifies the registration message and sends the modified registration message to an HLR associated with the HPMN, in order to cause the HLR to send a trigger profile information in a registration acknowledgement message to the SG. The modified registration message imitates the VPMN's roaming support for WIN phase 2 at the HLR that already supports WIN phase 2. In an embodiment of the present invention, SG-V 102 modifies the REGNOT message by adding WIN Capability (WINCAP), and replacing Transaction Capability (TRANSCAP) with a modified TRANSCAP to imitate at HLR-H 112 that VPMN 104 has WIN phase 2 support. Additionally, SG-V 102 modifies VMSC/VLR-V 110 address in the REGNOT message with a GT of VPMN 104. This ensures that signaling messages that are sent in response to the messages with CgPA as the GT of VPMN 104 are received at SG-V 102. It will be apparent to a person skilled in the art that any component (i.e. apart from SG-V 102) in VPMN 104 can imitate WIN phase 2 capabilities of VPMN 104 at any component (like prepaid SCP-H 114, apart from HLR-H 112) in HPMN 108. These modifications cause HLR-H 112 to send trigger profile information, such as TRIGADDRLIST in the registration acknowledgement message, such as ‘regnot’, to SG-V 102. It will be apparent to a person skilled in the art that TRIGADDRLIST provides a list of WIN triggers and destination SCP addresses to the requesting party (i.e. SG-V 102 in this case). Finally, at step 206, the SG facilitates the prepaid subscriber's mobile communication in the VPMN, by sending a modified registration acknowledgement message to a VMSC/VLR associated with the VPMN. In an embodiment of the present invention, SG-V 102 prefixes an MDN of subscriber 106 in the ‘regnot’ message, in order to distinguish this MDN with other MDN(s) received at VMSC/VLR-V 110. Thereafter, SG-V 102 sends this prefixed MDN in the ‘regnot’ message to VMSC/VLR-V 110 for further processing. Various embodiments for allowing subscriber to initiate and receive calls in partner VPMN 104 are described later in conjunction with FIGS. 4A, 4B, and 4C, and FIGS. 5A, 5B, and 5C, respectively.

It will be apparent to a person skilled in the art that in order to avoid looping of routing of signaling messages, the operator in VPMN 104 can perform routing of signaling messages either using a Translation Types (or tables) (TT) or using an Message Transfer Part (MTP) routing technique. In case the TT technique is used, the operator in VPMN 104 configures STP-V 116 for both incoming and outgoing international SCCP signaling messages. For example, in case of an incoming message at STP-V 116 with TT as 0, Calling Party Address (CgPA) as HPMN 108, and Numbering Plan (NP) as E.212 address of a Mobile Identification Number (MIN), Destination Point Code (DPC) is set to SG-V 102 and the destination TT as 32. In case of an outgoing message from STP-V 116 with the TT as 32, Called Party Address (CdPA) as HPMN 108, and the NP as E.212, the DPC is set to ISTP-V 118 and the destination TT as 0. Routing Indicator (RI) and SCCP CdPA GT in all these cases will remain unchanged.

Considering the second technique of using MTP routing, the operator in VPMN 104 configures STP-V 116 to send an incoming message, with NP as E.212 and CgPA as HPMN 108, to the DPC as SG-V 102. SG-V 102 is configured for an international (i.e. HPMN 108) destined outgoing signaling message from SG-V 102 to STP-V 116, the DPC is set to ISTP-V 118, with RI and SCCP CdPA GT unchanged. In other words, in MTP routing technique involving outgoing messages, SG-V 102 using TT as 0 or unknown will have a GT translation that has DPC set to ISTP-V 118, with the SCCP message being sent to STP-V 116 first. Based on different incoming and outgoing messages from STP-V 116, SG-V 102 routes various MAP messages to allow subscriber 106 of WIN phase 2 capable HPMN 108 to register at VPMN 104, and subsequently facilitate mobile activities with WIN phase 2 support, even when VPMN 104 is a non-WIN phase 2 network.

Further, in order to allow subscriber 106 to register with WIN phase 2 capabilities in VPMN 104, various other configurations are performed at SG-V 102. In an embodiment of the present invention, the operator in VPMN 104 configures STP-V 116 to redirect all SCCP signaling messages corresponding to subscriber 106, destined for HPMN 108, to SG-V 102. In other words, signaling messages with SCCP CdPA as HPMN 108 (i.e. E.212 address of MIN) are sent to SG-V 102 first. Thereafter, SG-V 102 modifies various MAP parameters in the received signaling message before routing the modified SCCP message to STP-V 116. In order to avoid looping of routing of signaling messages, the operator in VPMN 104 can route these messages using either TT or MTP routing techniques.

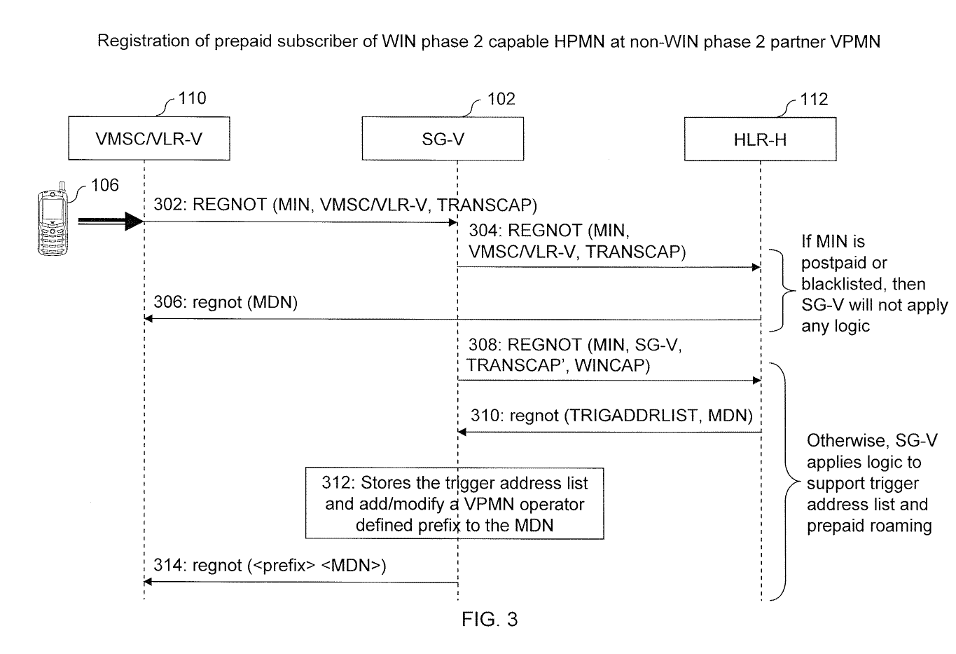

In order to avail various standard services (like initiate calls and SMS, and receive calls and SMS) in addition to WIN phase 2 specific services in VPMN 104, subscriber 106 first needs to register with VPMN 104. FIG. 3 represents a flow diagram of the registration process of prepaid subscriber 106 in partner VPMN 104, in accordance with an embodiment of the present invention. When subscriber 106 attempts to register at VPMN 104, VMSC/VLR-V 110 receives a registration message from a MIN of subscriber 106. At step 302, VMSC/VLR-V 110 sends the registration message such as REGNOT on the MIN of subscriber 106 to SG-V 102, with a VMSC/VLR-V 110 address, an Electronic Serial Number (ESN), and a TRANSCAP parameter indicating triggers supported by VMSC/VLR-V 110. In one embodiment of the present invention, SG-V 102 stores subscriber 106's profile information (i.e. VMSC/VLR-V 110 address, ESN, MIN) received in the REGNOT message. It will be apparent to a person skilled in the art that VMSC/VLR-V 110 first sends the REGNOT message to STP-V 116, which then redirects the message to SG-V 102 as per the configuration done at STP-V 116. SG-V 102 then applies various application logics to determine if the MIN is postpaid or blacklisted.

In case MIN is determined to be postpaid or blacklisted, then at step 304, SG-V 102 bypasses (i.e. does not perform any further logic) the REGNOT message to HLR-H 112 (via STP-V 116). In an embodiment of the present invention, SG-V 102 determines the MIN either based on the MIN range (i.e. usually of 15 digits) or based on subscriber 106's profile information (i.e. retrieved from the REGNOT message, at step 302). Thereafter, at step 306, HLR-H 112 returns a registration acknowledgement message such as ‘regnot’ on an MDN of subscriber 106 directly to VMSC/VLR-V 110. It will be apparent to a person skilled in the art that in case the MIN is determined to be postpaid, the subscriber will register at VPMN 104 normally, without any intervention of SG-V 102 in any further process related to this postpaid subscriber. However, in case the MIN is determined to be blacklisted, SG-V 102 blocks the MIN, and hence the postpaid subscriber will not be able to register at VPMN 104.

Alternatively, SG-V 102 may determine the MIN as prepaid and not blacklisted, and in such a case will perform further application logics on the received REGNOT message (i.e. at step 302) to imitate VPMN 104's roaming support for WIN phase 2 at HLR-H 112. Hence, at step 308, SG-V 102 modifies the REGNOT message by replacing the TRANSCAP parameter (i.e. received at step 302) with a modified TRANSCAP parameter to update at HLR-H 112 that VPMN 104 has a WIN phase 2 trigger profile information support (i.e. TRIGADDRLIST support). SG-V 102 also adds a WINCAP parameter in the modified REGNOT message to update at HLR-H 112 that VPMN 104 has WIN phase 2 prepaid roaming support. The prepaid roaming support corresponds to WIN phase 2 trigger type support (like OANSWER and TANSWER) and WIN phase 2 prepaid operations (like CCDIR and RESETTIMER), in accordance with various embodiments of the present invention. Additionally, SG-V 102 also replaces VMSC/VLR-V 110 address with the GT of VPMN 104 (i.e. SG-V GT or selects a GT from a pool of GTs). This causes HLR-H 112, at step 310, to return roaming profile information such as an MDN of subscriber 106 and trigger profile information (i.e. TRIGADDRLIST) in a registration acknowledgement message, such as ‘regnot’, to SG-V 102. Thereafter, at step 312, SG-V 102 stores the TRIGADDRLIST and the MDN received in the ‘regnot’ message, and adds a prefix (which is configurable by the operator in VPMN 104) to this MDN. For example, the operator in VPMN 104 can add a prefix like ‘11’ or ‘#’ or ‘*167’ to the MDN.

Finally, at step 314, SG-V 102 modifies a sender ID number and sets SCCP CgPA to SG-V 102, and subsequently sends the modified ‘regnot’ message (i.e. with prefixed MDN), without any roaming profile information to VMSC/VLR-V 110. It will be apparent to a person skilled in the art that the sender ID number corresponds to the GT of the sending party (e.g. VMSC/VLR-V 110) that is sending an SCCP message (e.g. REGNOT). In an embodiment of the present invention, VMSC/VLR-V 110 creates the ISUP voice trunk loopback with SG-V 102, in order to facilitate completion of the ongoing registration process. The modification of sender ID number and CgPA ensures that further signaling corresponding to subscriber 106, received at VMSC/VLR-V 110, is subsequently redirected via SG-V 102. Moreover, by sending the prefixed MDN to VMSC/VLR-V 110, SG-V 102 ensures that the call request on this prefixed MDN is received at SG-V 102 from VMSC/VLR-V 110.

Various other E.212 signaling messages (i.e. other than REGNOT) such as Qualification Request (QUALREQ), Qualification Directive (QUALDIR), Authentication Request (AUTHREQ), and AUTHDIR can be handled in a manner similar to the REGNOT message. It will be apparent to a person skilled in the art that QUALREQ is used to validate subscriber or to request subscriber's profile information, or both, whereas QUALDIR is used to update authorization information, profile information, or both. It will also be apparent to a person skilled in the art that AUTHREQ is used to request authentication of an authentication-capable subscriber, whereas AUTHDIR is used to request modification of subscriber's authentication parameters.

Once subscriber 106 is registered at VPMN 104, he can initiate calls in VPMN 104 that are WIN phase 2 compliant. However, this requires SG-V 102 to apply application logics based on the prefix of the calling number's MDN. FIGS. 4A, 4B, and 4C represent a flow diagram of MO call from prepaid subscriber 106's handset while roaming in partner VPMN 104, in accordance with an embodiment of the present invention. When subscriber 106 initiates a call using his MDN to a called party ‘B’, a call request first reaches VMSC/VLR-V 110. Thereafter, at step 402, since VMSC/VLR-V 110 determines the MDN as a prefixed MDN, it routes the call request using an Initial Address Message (IAM) (<prefix> <MDN>, B) via ISUP to SG-V 102. Thereafter, SG-V 102 removes the prefix from the prefixed MDN to obtain the original MDN. Using the original MDN, SG-V 102 determines its corresponding MIN and fake location of subscriber 106 (i.e. SG-V 102 GT). Additionally, SG-V 102 also determines prepaid SCP-H 114 from the TRIGADDRLIST (i.e. stored at SG-V 102 in FIG. 3). Thereafter, at step 404, SG-V 102 issues an Origination Request (ORREQ) operation on the MIN and the original MDN to prepaid SCP-H 114, with WINCAP and modified TRANSCAP parameters, and CgPA as SG-V GT. ORREQ operation is used to request call origination treatment on behalf of a registered subscriber (i.e. subscriber 106 who is registered at VPMN 104). Furthermore, in various embodiments of the present invention, WINCAP operation will not support messages such as Connect Resource (CONNRES) and Disconnect Resource (DISCONNRES) when imitating WIN phase 2 WINCAP support at prepaid SCP-H 114. This is done to avoid any international voice connection to an Intelligent Peripheral (IP) associated with HPMN 108. CONNRES and DISCONNRES are used to request for establishing a connection and releasing an already established connection, respectively.

Further, at step 406, prepaid SCP-H 114 returns an acknowledgement message, such as ‘orreq’ to SG-V 102 with a prepaid indication that instructs SG-V 102 to proceed with the call. In an embodiment of the present invention, the ‘orreq’ message provides routing information to SG-V 102. Thereafter, at step 408, SG-V 102 sends an Analyzed Information (ANLYZD) operation on the MIN and MDN to prepaid SCP-H 114, with WINCAP and modified TRANSCAP parameters, and CgPA as SG-V 102 address. ANLYZD operation is used to notify prepaid SCP-H 114 that trigger criteria at an Analyzed-Information Detection Point (DP) has been satisfied, and thereby prepaid SCP-H 114 can continue with the call processing. Thereafter, at step 410, prepaid SCP-H 114 returns an acknowledgement message such as ‘anlyzd’ to SG-V 102 that instructs SG-V 102 to continue with the ongoing call processing. Hence, at step 412, SG-V 102 issues ISUP IAM (MDN, B) to VMSC/VLR-V 110. Thereafter, at step 414, VMSC/VLR-V 110 sends Address Completion Message (ACM) to SG-V 102, which at step 416 returns an acknowledgement ACM message to VMSC/VLR-V 110, in order to confirm that voice trunks are reserved for the call setup. Further, at step 418, VMSC/VLR-V 110 issues Answer Message (ANM) to SG-V 102. This confirms that VMSC/VLR-V 110 has established the trunk for the ongoing call, and that the called party ‘B’ has answered the call. At step 420, SG-V 102 sends an OANSWER operation on the MIN and MDN to prepaid SCP-H 114, with WINCAP and modified TRANSCAP parameters, and CgPA as SG-V 102 address. It will be apparent to a person skilled in the art that O_Answer is an indication that the called party has answered the call. Thereafter, at step 422, prepaid SCP-H 114 returns an acknowledgement message such as ‘oanswer’ to SG-V 102. Thus, prepaid SCP-H 114 can begin the prepaid billing for subscriber 106's MDN. Further, at step 424, SG-V 102 sends an acknowledgement ANM message to VMSC/VLR-V 110.

In one embodiment of the present invention, prepaid SCP-H 114 can play a recording on subscriber 106's MDN while the call is in progress. Hence, at step 426, prepaid SCP-H 114 sends a Call Control Directive (CCDIR) operation with an AoC, balance, and announcement list to SG-V 102, while the call is in progress. CCDIR operation is used during call processing to control VMSC (which is VMSC-V 110) operation for the indicated call. In case SG-V 102 has a service node that supports ISUP voice trunking interface with VMSC/VLR-V 110, SG-V 102 can directly play the AoC, balance and announcement list, at step 428. In an exemplary case, subscriber 106 may listen to a recording that says, “Your prepaid account balance is low. Kindly recharge your prepaid account to continue uninterrupted services”. However, in an alternate embodiment, when SG-V 102 does not have any service node, it can simply send an acknowledgement ‘ccdir’ message to prepaid SCP-H 114, without playing any announcement. Thus, at step 430, SG-V 102 sends ‘ccdir’ message to prepaid SCP-H 114. Further, at step 432, prepaid SCP-H 114 sends a RESETTIMER operation to SG-V 102, which at step 434 returns an acknowledgement ‘resettimer’ message to prepaid SCP-H 114. RESETTIMER operation is used to initialize and start an operation timer, and avoid the timeout that would otherwise occur and cause false billing. Steps 426 to 434 are optional, and hence represented in dashed line in FIGS. 4A, 4B, and 4C.

In another embodiment of the present invention, prepaid account of subscriber 106 may not be sufficient to continue the ongoing call. Hence, in such a case, at step 436, prepaid SCP-H 114 stops the billing and subsequently issues a CCDIR operation to SG-V 102, in order to request disconnection of the ongoing call. In one embodiment of the present invention, SG-V 102 makes an announcement for disconnecting the ongoing call, in case SG-V 102 supports voice trunking with VMSC/VLR-V 110. In an exemplary scenario, SG-V 102 intimates subscriber 106 for disconnecting the ongoing call, by playing a recording that says, “Balance in your prepaid account is not sufficient to continue the ongoing call. Please recharge your account to avoid any further inconvenience”. Thereafter, at step 438, SG-V 102 releases the call on the MDN by sending a release message such as REL to VMSC/VLR-V 110. Further, at step 440, VMSC/VLR-V 110 sends an acknowledgement Release Complete (RLC) message to SG-V 102, in order to release the voice trunk used for the call setup. At step 442, SG-V 102 sends an acknowledgement ‘ccdir’ message to prepaid SCP-H 114.

In yet another embodiment of the present invention, subscriber 106 may disconnect the ongoing call. Thus, at step 444, VMSC/VLR-V 110 sends an REL message to SG-V 102, which at step 446 sends an ODISCONNECT operation on the MIN and MDN to prepaid SCP-H 114, with the WINCAP and modified TRANSCAP parameters, and CgPA as SG-V 102 address. Thereafter, at step 448, prepaid SCP-H 114 stops the billing on subscriber 106's MDN, and responds with an acknowledgement ‘odisconnect’ message to SG-V 102. Subsequently, at step 450, SG-V 102 issues an acknowledgement REL message to VMSC/VLR-V 110, in order to terminate the ongoing call processing. This causes VMSC/VLR-V 110, at step 452, to issue an RLC message to SG-V 102, in order to release the voice trunk used for the call setup. Finally, at step 454, SG-V 102 sends an acknowledgement RLC message to VMSC/VLR-V 110.

As mentioned earlier, subscriber 106 can also receive calls while he is roaming in non-WIN phase 2 partner VPMN 104. FIGS. 5A, 5B, and 5C represent a flow diagram of MT call received on prepaid subscriber 106's handset while roaming in partner VPMN 104, in accordance with an embodiment of the present invention. At step 502, when a calling party ‘B’ calls subscriber 106's MDN, call request IAM (B, MDN) is received at a Gateway MSC (GMSC) 503 coupled to HPMN 108. As GMSC 503 resides in HPMN 108, it is hereinafter referred to as GMSC-H 503. Upon receiving the terminating call request for subscriber 106, GMSC-H 503 sends a Location Request (LOCREQ) message on the MDN to HLR-H 112, with WINCAP and TRANSCAP parameters to request for WIN phase 2 trigger profile information, at step 504. Thus, at step 506, HLR-H 112 returns the trigger profile information (i.e. TRIGADDRLIST) and subscriber 106's location (i.e. GT of VPMN 104) in an acknowledgement ‘locreq’ message to GMSC-H 503. HLR-H 112 returns subscriber 106's location due to fake registration process (i.e. performed earlier) of subscriber 106 in VPMN 104. Thereafter, at step 508, GMSC-H 503 sends an ANLYZD message to prepaid SCP-H 114, with the calling party ‘B’ number, MDN, MIN, and address of SG-V 102. Prepaid SCP-H 114 then returns instructions to GMSC-H 503 to continue the call processing in an acknowledgement ‘anlyzd’ message, at step 510.

In an embodiment of the present invention, in case GMSC-H 503 has not received subscriber 106's location information (i.e. SG-V 102 address) in the ‘locreq’ message, then at step 512, GMSC-H 503 sends a second LOCREQ message on the MDN to HLR-H 112, with the WINCAP and TRANSCAP parameters requesting routing information from HLR-H 112. Therefore, at step 514, HLR-H 112 sends a routing request message, such as ROUTREQ on subscriber 106's MIN to SG-V 102, which at step 516 is relayed to VMSC/VLR-V 110. Further, at step 518, VMSC/VLR-V 110 assigns a Temporary Local Directory Number (TLDN) for the called MDN and returns the assigned TLDN in an acknowledgement ‘routreq’ message to SG-V 102, which at step 520 is relayed to HLR-H 112. Thereafter, at step 522, HLR-H 112 returns the TLDN and the routing information to GMSC-H 503 in an acknowledgement ‘locreq’ message.

Since GMSC-H 503 has the TLDN and routing information, it uses this information to modify the call request as IAM (B, TLDN) and sends it to VMSC/VLR-V 110, at step 524. Thereafter, at step 526, VMSC/VLR-V 110 issues ACM and subsequently ANM to GMSC-H 503, in order to indicate that voice trunks for the ongoing call are reserved and subscriber 106 has answered the call, respectively. At step 528, GMSC-H 503 sends a TANSWER message on the MDN to prepaid SCP-H 114, with the WINCAP and TRANSCAP parameters. Prepaid SCP-H 114 then starts the billing on subscriber 106's MDN. In an embodiment of the present invention, prepaid SCP-H 114 is defined with a tariff plan for subscriber 106 based on his current location, in case the tariff for that location is not defined until that point. This is required as prepaid SCP-H 114 does not know the tariff plan specific to the location of subscriber 106, and hence is unable to correctly bill subscriber 106's MDN. Further, at step 530, prepaid SCP-H 114 returns an acknowledgement ‘tanswer’ message to GMSC-H 503 to indicate the continuation of call processing.

In an embodiment of the present invention, subscriber 106 may disconnect the ongoing call. Hence, in such a case, VMSC/VLR-V 110 at step 532 sends a release message, such as REL to GMSC-H 503 indicating termination of the call by subscriber 106. Thereafter, at step 534, GMSC-H 503 sends a TDISCONNECT message on the MDN to prepaid SCP-H 114, with the WINCAP and TRANSCAP parameters. This results in prepaid SCP-H 114 to stop the billing on subscriber 106's MDN. In addition, at step 536, prepaid SCP-H 114 responds with an acknowledgement ‘tdisconnect’ message to GMSC-H 503. This causes GMSC-H 503, at step 538, to release the trunk by sending an RLC message to VMSC/VLR-V 110.

In an alternate embodiment of the present invention, in case the balance in the prepaid account of subscriber 106 is not sufficient to pursue the ongoing call, prepaid SCP-H 114 stops the billing and issues a CCDIR operation to GMSC-H 503 at step 540, in order to request for disconnection of the ongoing call. Thus, at step 542, GMSC-H 503 sends an acknowledgement ‘ccdir’ message to prepaid SCP-H 114. Thereafter, at step 544, GMSC-H 503 releases the call on subscriber 106's MDN by sending a release message such as REL to VMSC/VLR-V 110. This finally causes VMSC/VLR-V 110, at step 546, to send an acknowledgement RLC message to GMSC-H 503, in order to release the voice trunk.

In an embodiment of the present invention, subscriber 106 may also wish to initiate SMS, while he is roaming in VPMN 104. The call flow for MO SMS follows a standard MO SMS call flow, where a subscriber sends an SMS to a destination number, which reaches his HPMN MC (i.e. Message Center coupled to HPMN 108) without involving SG-V 102. It will be apparent to a person skilled in the art that in case CdPA is HPMN MC, then the routing is done on E.164 address of HPMN MC. As there is no configuration done at any of the components in VPMN 104 for redirecting E.164 address, normal flow of the SMS will take place. In another embodiment of the present invention, in case the subscriber's SMS is destined to HPMN MIN, and since the operator in VPMN 104 has done a configuration to route E.212 address of the MIN (i.e. HPMN MIN) to SG-V 102, the subscriber's SMS will be first received at SG-V 102. However, SG-V 102 will not perform any modification (or apply any logic), but will simply route the received SMS to the HPMN MC. The rest of the SMS delivery flow will be similar to standard SMS message flow.

In another embodiment of the present invention, subscriber 106 may receive an MT-SMS while roaming in VPMN 104. In this case, when an SMS for the subscriber's MDN is received at an originating MC, the originating MC will send a routing information request, such as SMS Request (SMSREQ) on the subscriber's MDN, to HLR-H 112. SMSREQ is sent to HLR-H 112 to determine the location of subscriber 106, and to check whether subscriber 106 is allowed to receive SMS. HLR-H 112 will then return SG-V 102 address and MIN corresponding to subscriber 106's MDN, to the originating MC. Thereafter, the originating MC can forward the SMS by sending an SMS Delivery Point to Point (SMDPP) message to SG-V 102, which can further relay to VMSC/VLR-V 110 (that is eventually delivered to subscriber 106's handset). In an embodiment of the present invention, when subscriber 106 is unable to receive the SMS, the originating MC will retain the SMS, and will resend when VMSC/VLR-V 110 later indicates the availability of subscriber 106.

The prepaid solution explained above has described a CDMA solution to allow subscribers of WIN phase 2 capable HPMN to roam in non-phase 2 partner VPMN, and thereby avail WIN phase 2 services while roaming in this partner VPMN. It will be apparent to a person skilled in the art that similar prepaid roaming solution can also be provided to subscribers using the GSM standard. However, in this case, the HPMN would have CAMEL or IN support, while the partner VPMN would not be having roaming support for CAMEL or IN. The solution will involve the partner VPMN implementing ISUP voice trunk loopback to SG-V 102 for special prefixed calling numbers (i.e. the prefix is added by SG-V 102 to these calling numbers). In an embodiment of the present invention, in case the partner VPMN supports Intelligent Network Application Part (INAP) protocol, SG-V 102 will interact with VMSC/VLR-V 110 via INAP protocol, instead of ISUP. However, this requires IN triggers that can be defined on calling number prefixes. SG-V 102, in case of GSM, will interact with prepaid SCP-H 114 via Camel Application Part (CAP) protocol. In addition, even in GSM solution, as in CDMA solution, STP-V 116 will be configured to redirect signaling messages with CdPA as HPMN, to SG-V 102. Further, SG-V 102 will imitate partner VPMN's CAMEL support at HLR-H 112, in order to receive subscriber 106's roaming profile information from HLR-H 112.

It will also be apparent to a person skilled in the art that the prepaid roaming solution can be provided to subscribers using other technologies such as, but not limited to, VoIP, WiFi, 2G, 3G, and inter-standard roaming. For example, a 3G roaming subscriber traveling to a VPMN may like to avail wireless services similar to the ones he receives in his HPMN. To support these variations, SG-V 102 will have a separate SS7 and network interface corresponding to both the VPMN network and the HPMN network. It would be obvious to a person skilled in the art that these two interfaces in different directions may not have to be the same technologies. In addition, there could be multiple types of interfaces in both directions.

An exemplary list of the mapping between GSM MAP/CAP and ANSI41D is described in the table below as a reference.

| GSM MAP/CAP | ANSI 41D |
|---|---|
| Location Update/ISD | REGNOT |
| Cancel Location | REGCAN |
| RegisterSS | FEATUREREQUEST |
| InterrogateSS | FEATUREREQUEST |
| SRI-SM | SMSREQ |
| SRI | LOCREQ |
| ForwardSMS | SMSDPP |
| ReadyForSMS | SMSNOTIFICATION |
| AlertServiceCenter | SMSNOTIFICATION |
| ReportSMSDelivery | SMDPP |
| ProvideRoamingNumber | ROUTREQ |
| Initial DP | ORREQ |
| Initial DP | ANLYZD |
| Initial DP | OANSWER |
| Connect/ReleaseCall/Continue/Cancel | CCDIR |
| Reset Timer | RESETTIMER |
| Initial DP | ODISCONNECT |
| Initial DP | TANSWER |
| Initial DP | TDISCONNECT |

An HPMN operator, or a partner VPMN operator or an MVNO operator of the HPMN operator uses one or more variations of the present invention to allow prepaid subscribers of WIN phase 2 (or CAMEL) HPMN to outbound roam with WIN phase 2 (or CAMEL) capabilities in the non-WIN phase 2 (or non-CAMEL) partner VPMN. The present invention helps the HPMN prepaid subscribers to avail standard services (like initiate calls and SMS, and receive calls and SMS) in addition to WIN phase 2 specific services, while roaming in the partner VPMN. This result in attracting more of outbound roaming HPMN prepaid subscribers to register at the partner VPMN. In addition, cutting down the cost of upgrading existing components and installing new components to the existing network eventually leads to maximizing roaming revenues for network operator deploying this solution.

The present invention can take the form of an entirely hardware embodiment, an entirely software embodiment, or an embodiment containing both hardware and software elements. In accordance with an embodiment of the present invention, software, including but not limited to, firmware, resident software, and microcode, implements the invention.

Furthermore, the invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

A computer usable medium provided herein includes a computer usable program code, which when executed, provides wireless services to a prepaid subscriber of an HPMN in a VPMN. The computer program product further includes a computer usable program code for detecting at a Signal Gateway (SG) coupled to the VPMN, a registration attempt by the prepaid subscriber at the VPMN having a non-WIN phase 2 support. The computer program product further includes a computer usable program code for causing an HLR associated with the HPMN to send a trigger profile information in a registration acknowledgement message to the SG in response to a modified registration message, sent by the SG to imitate the VPMN's roaming support for WIN phase 2 at the HLR that has a WIN phase 2 support. The computer program product further includes a computer usable program code for sending by the SG, a modified registration acknowledgement message to a VMSC/VLR associated with the VPMN to facilitate the prepaid subscriber's mobile communication in the VPMN.

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the present system is not intended to be exhaustive or to limit the present system to the precise form disclosed. While specific embodiments of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various embodiments described above can be combined to provide further embodiments. These and other changes can be made in light of the above detailed description.

Other Variations

Provided above for the edification of those of ordinary skill in the art, and not as a limitation on the scope of the invention, are detailed illustrations of a scheme for providing wireless services to a prepaid subscriber of an HPMN roaming in a VPMN. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However, the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However, use of these examples should not be interpreted as limiting the invention to those media. The system and method can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the system under the present invention, this specification follows the path of a telecommunications call, from a calling party to a called party. For the avoidance of doubt, such a call can be a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

APPENDIX

| Acronym | Description |
|---|---|
| 3G | Third Generation of mobile |
| 3GPP | Third Generation Partnership Project |
| ACM | ISUP Address Completion Message |
| ANLYZD | Analyzed Information |
| ANM | ISUP Answer Message |
| ANSI-41 | American National Standards Institute #41 |
| AUTHDIR | Authentication Directive |
| AUTHREQ | Authentication Request |
| CAMEL | Customized Applications for Mobile network |
| | Enhanced Logic |
| CAP | Camel Application Part |
| CCDIR | Call Control Directive |
| CDMA | Code Division Multiplexed Access |
| CdPA | Called Party Address |
| CgPA | Calling Party Address |
| CONNRES | Connect Resource |
| DISCONNRES | Disconnect Resource |
| DP | Detection Point |
| DPC | Destination Point Code |
| DSD | Delete Subscriber Data |
| ESN | Electronic Serial Number |
| GMSC | Gateway MSC |
| GPRS | General Packet Radio System |
| GSM | Global System for Mobile |
| GT | Global Title |
| HLR | Home Location Register |
| HLR-H | HPMN HLR |
| HPMN | Home Public Mobile Network |
| IAM | Initial Address Message |
| IN | Intelligent Network |
| IP | Intelligent Peripheral |
| IS-41 | Interim Standard-41 |
| ISD | MAP Insert Subscriber Data |
| ISTP | International STP |
| ISUP | ISDN User Part |
| LOCREQ | Location Request |
| LUP | MAP Location Update |
| MAP | Mobile Application Part |
| MC | Message Center |
| MDN | Mobile Directory Number |
| MIN | Mobile Identification Number |
| MO | Mobile Originated |
| MSC | Mobile Switching Center |
| MT | Mobile Terminated |
| MTP | Message Transfer Part |
| MVNO | Mobile Virtual Network Operator |
| NP | Numbering Plan |
| OANSWER | Origination Answer |
| ODISCONNECT | Origination Disconnect |
| ORREQ | Origination Request |
| NPI | Numbering Plan Indicator |
| QUALDIR | Qualification Directive |
| QUALREQ | Qualification Request |
| REGCAN | Registration Cancellation |
| REGNOT | MAP Registration Notification |
| ROUTREQ | Routing Request |
| PRN | MAP Provide Roaming Number |
| REL | ISUP Release Message |
| RI | Routing Indicator |
| SCCP | Signaling Connection Control part |
| SCP | Signaling Control Point |
| SG | Signal Gateway |
| SMS | Short Message Service |
| SMDPP | SMS Delivery Point to Point |
| SMSREQ | SMS Request |
| SN | Service Node |
| SPC | Signaling Point Code |
| SRI | MAP Send Routing Information |
| SRI-SM | MAP Send Routing Information For Short Message |
| SS7 | Signaling System #7 |
| SSP | Service Switch Point |
| STP | Signaling Transfer Point |
| TANSWER | Termination Answer |
| TCAP | Transaction Capabilities Application Part |
| TDISCONNECT | Termination Disconnect |
| TLDN | Temporary Local Directory Number |
| TRANSCAP | Transaction Capability |
| TT | Translation Type |
| USSD | Unstructured Supplementary Service Data |
| VAS | Value Added Service |
| VLR | Visited Location Register |
| VLR-V | VPMN VLR |
| VMSC | Visited Mobile Switching Center |
| VMSC-V | VPMN VMSC |
| VPMN | Visited Public Mobile Network |
| WIN | Wireless Intelligent Network |
| WINCAP | WIN Capability |

### TECHNICAL REFERENCES

### Each of which is Incorporated by this Reference Herein

GSM 902 on MAP specification
Digital cellular telecommunications system (Phase 2+)
Mobile Application Part (MAP) Specification
(3GPP TS 09.02 version 7.9.0 Release 1998).
GSM 340 on SMS
Digital cellular telecommunications system (Phase 2+)
Technical realization of the Short Message Service (SMS)
(GSM 03.40 version 7.4.0 Release 1998).
GSM 378 on CAMEL,
GSM 978 on CAMEL Application Protocol,
GSM 379 on CAMEL Support of Optimal Routing (SOR),
GSM 318 on CAMEL Basic Call Handling.
ITU-T Recommendation Q.1214 (1995), Distributed functional plane for intelligent network CS-1,
ITU-T Recommendation Q.1218 (1995), Interface Recommendation for intelligent network CS-1,
ITU-T Recommendation Q.762 (1999), Signaling system No. 7—ISDN user part general functions of messages and signals,
ITU-T Recommendation Q.763 (1999), Signaling system No. 7—ISDN user part formats and codes,
ITU-T Recommendation Q.764 (1999), Signaling system No. 7—ISDN user part signaling procedures,
ITU-T Recommendation Q.766 (1993), Performance objectives in the integrated services digital network application,
ITU-T Recommendation Q.765 (1998), Signaling system No. 7—Application transport mechanism,
ITU-T Recommendation Q.769.1 (1999), Signaling system No. 7—ISDN user part enhancements for the support of Number Portability.
IS-41 D MAP,
IS-771 WIN Phase 1,
IS-826 WIN Phase 2 Prepaid Charging,
IS-848 WIN Phase 2 additional applications,
IS-843 WIN Phase 3 location-based applications

I claim:

1. A system for providing wireless services to a prepaid subscriber of a Home Public Mobile Network (HPMN) in a Visited Public Mobile Network (VPMN), the HPMN having Wireless Intelligent Network (WIN) phase 2 capability and an associated Home Location Register (HLR), the VPMN having non-WIN phase 2 capability and an associated Visited Mobile Switching Center/Visited Location Register (VMSC/VLR), the system comprising:
a Signal Gateway (SG) coupled to the VPMN for detecting a registration attempt by the prepaid subscriber at the VPMN;
circuitry for sending a modified registration message to imitate the VPMN's roaming support for WIN phase 2 capability at the HLR;
circuitry for causing the HLR to send a registration acknowledgement message with trigger profile information to the first SG in response to the first modified registration message; and
circuitry for sending a modified registration acknowledgement message to the VMSC/VLR to facilitate the prepaid subscriber's mobile communication in the VPMN.

2. The system of claim 1, wherein the prepaid subscriber has a Mobile Directory Number (MDN);
wherein the trigger profile information is stored at the SG; and
wherein the SG modifies the registration acknowledgement message based on the trigger profile by adding a configurable prefix to the MDN to facilitate the prepaid subscriber's mobile communication.

3. The system of claim 1, wherein the VPMN has a VPMN Global Title (VPMN GT); and
wherein the SG updates the HLR by modifying an address of the VMSC/VLR in the registration message with the VPMN GT.

4. The system of claim 1, wherein VMSC/VLR sends a TRANSCAP parameter, which is received by the SG; and
wherein the TRANSCAP parameter is replaced with a modified TRANSCAP parameter indicating the VPMN's support for the trigger profile information to the HLR.

5. The system of claim 1, wherein the SG modifies the registration message by adding a WIN Capability (WINCAP) parameter to indicate the VPMN's prepaid roaming support for WIN phase 2 at the HLR.

6. The system of claim 1, wherein the VPMN has an associated roaming Signaling Transfer Point (STP) configured to redirect all signaling messages corresponding to the prepaid subscriber, destined for the HPMN, to the SG.

7. The system of claim 1, wherein the VMSC/VLR is configured to establish a connection from one selected from a group consisting of an ISDN User Part (ISUP) voice trunk loopback and an ISUP signaling, to the SG to route all signaling messages corresponding to the prepaid subscriber.

8. A method of providing wireless services to a prepaid subscriber of a Home Public Mobile Network (HPMN) in a Visited Public Mobile Network (VPMN), the HPMN having Wireless Intelligent Network (WIN) phase 2 capability and an associated Home Location Register (HLR), the VPMN having non-WIN phase 2 capability and an associated Visited Mobile Switching Center/Visited Location Register (VMSC/VLR), the method comprising:
detecting a registration attempt by the prepaid subscriber at the VPMN via a Signal Gateway (SG);
sending a first modified registration message to imitate the VPMN's roaming support for WIN phase 2 capability at the HLR;
sending, via the HLR, a registration acknowledgement message with trigger profile information to the SG in response to the first modified registration message; and
sending a second modified registration acknowledgement message to the VMSC/VLR to facilitate the prepaid subscriber's mobile communication in the VPMN.

9. The method of claim 8, wherein the prepaid subscriber has a Mobile Identification Number (MIN) and a MDN, wherein the HLR has a HLR address, and wherein the VMSC/VLR has a VMSC/VLR address, the method further comprising:
storing, at the SG, at least one selected from a group consisting of the trigger profile information, the MIN, the MDN the HLR address, and the VMSC/VLR address.

10. The method of claim 8, wherein the VPMN has a VPMN GT and the VMSC/VLR has a VMSC/VLR address; and
wherein the SG updates the HLR by modifying the VMSC/VLR address in the registration message with the VPMN GT.

11. The method of claim 8, wherein the VMSC/VLR sends a TRANSCAP parameter, which is received at the SG; and
wherein the TRANSCAP parameter is replaced with a modified TRANSCAP parameter indicating the VPMN's support for the trigger profile information.

12. The method of claim 8, wherein the SG modifies the registration message by adding a WINCAP parameter to indicate the VPMN's prepaid roaming support for WIN phase 2 at the HLR.

13. The method of claim 8, wherein a roaming STP associated with the VPMN is configured to redirect all signaling messages corresponding to the prepaid subscriber, destined for the HPMN, to the SG.

14. The method of claim 8, wherein the VMSC/VLR is configured to establish a connection from one selected from a group consisting of an ISDN User Part (ISUP) voice trunk loopback and an ISUP signaling, to the SG to route all signaling messages corresponding to the prepaid subscriber.

15. A computer program product comprising a computer usable medium including a computer usable program code stored thereon for providing wireless services to a prepaid subscriber of a Home Public Mobile Network (HPMN) in a Visited Public Mobile Network (VPMN), the HPMN having Wireless Intelligent Network (WIN) phase 2 capability and an associated Home Location Register (HLR), the VPMN having non-WIN phase 2 capability and an associated Visited Mobile Switching Center/Visited Location Register (VMSC/VLR), the computer program product comprising:
first computer useable program code means for detecting a registration attempt by the prepaid subscriber at the VPMN via a SG;
second computer useable program code means for sending a first modified registration message to imitate the VPMN's roaming support for WIN phase 2 capability at the HLR;
third computer useable program code means for sending, via the HLR, a registration acknowledgement message with trigger profile information to the SG in response to the first modified registration message; and
fourth computer useable program code means for sending a second modified registration acknowledgement message to the VMSC/VLR to facilitate the prepaid subscriber's mobile communication in the VPMN.
